(19) United States
(12) Patent Application Publication
(10) Pub. No.: US 2005/0274024 A1
(43) Pub. Date: Dec. 15, 2005

(54) Blade holder for a utility knife

(75) Inventor: Bai Jinliang, Nanjing (CN)

Correspondence Address: WOOD, HERRON & EVANS, LLP, 2700 CAREW TOWER, 441 VINE STREET, CINCINNATI, OH, 45202, US

(73) Assignee: Innovative Tools Inc., Hawi, HI (US)

(21) Appl. No.: 10/864,938

(22) Filed: Jun. 10, 2004

(51) Int. Cl. B26B 3/06; F41B 13/02

(52) U.S. Cl. 30/153

(57) ABSTRACT

A utility knife includes a blade holder that permits quick and easy removal and replacement of the utility knife blade. The utility knife includes a sleeve which receives the blade. The upper portion of the sleeve includes a pivoting arm which engages indentations in the trapezoidal utility knife blade holding the blade in position. By pressing down on one end of the arm, the arm disengages the trapezoidal blade allowing it to be removed and replaced.

### FIELD OF THE INVENTION

Utility knives generally include a device to hold a trapezoidal shaped blade. The blade typically can be reversed so that a single blade has two cutting tips. Thus, when one tip is dull the blade can be reversed.

There are several types of utility knives. Generally, these all have a handle which has two mirror-image sides held together by a screw. When one wants to change the blade, the two sides are separated and the blade is replaced.

There are utility knives which are similar to pocket knives. The blade is held in a sleeve. Again, generally these are designed with the sleeve formed from two portions that are separated from each other in order to replace the blade.

In either event, this method of changing blades is relatively time consuming.

### SUMMARY OF THE INVENTION

The present invention is a utility knife which enables rapid changing of the blade. More particularly, the present invention is a utility knife that includes a sleeve which holds the blade. The sleeve has a retaining arm. The arm is pivoted to permit the blade to be removed and replaced and pivots back into place to hold the blade in position for use. This is particularly suitable for a utility knife which has a folding blade holder like a pocket knife.

The objects and advantages of the present invention will be further appreciated in light of the following detailed description and drawings in which:

### BRIEF DESCRIPTION OF THE DRAWINGS

FIG. 1 is a perspective view of the present invention with the blade in a retracted position;

FIG. 2 is a planned view of the present invention with the rotation of the blade holder shown in phantom;

FIG. 3 is an exploded perspective view of the present invention;

FIG. 4 is a planned view of the present invention with a portion of the blade sleeve removed.

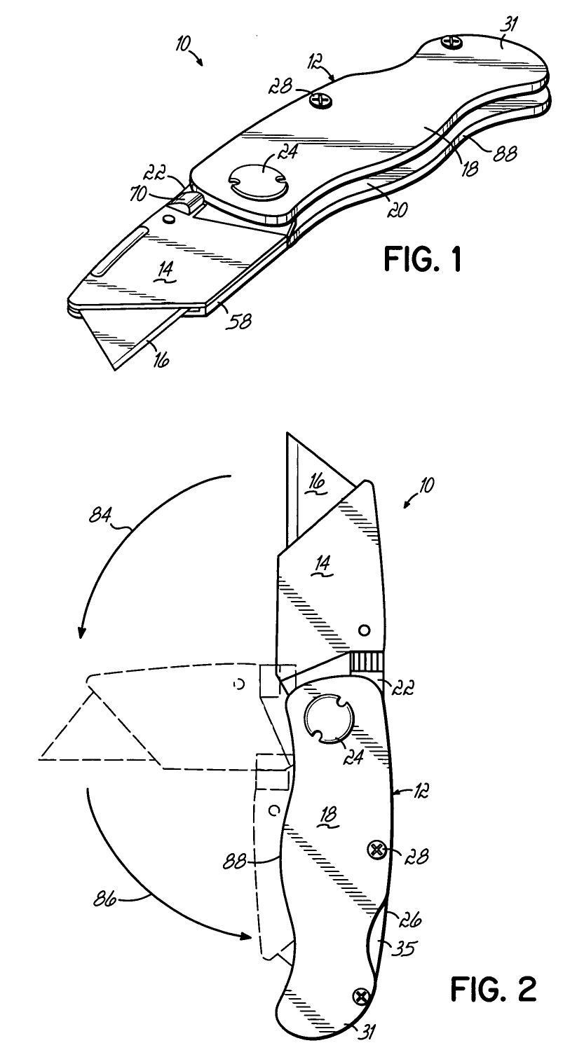

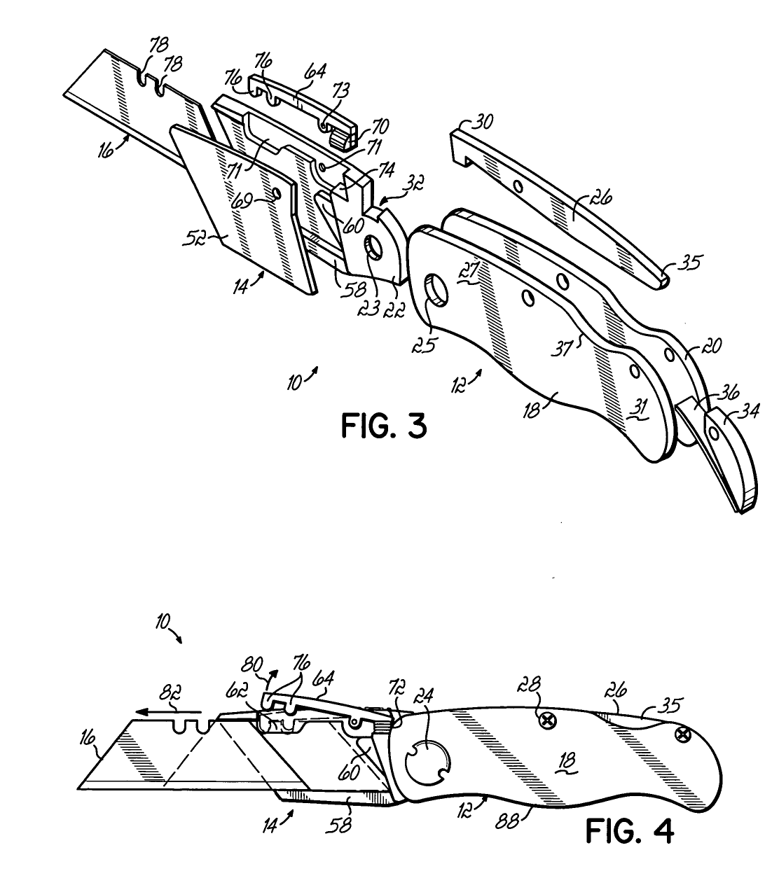

### DETAILED DESCRIPTION OF THE DRAWINGS

The present invention is a utility knife 10 which includes a handle 12 and a blade holder or sleeve 14 which retains blade 16. The handle is formed from left and right handle side members 18 and 20. The handle is pivotally attached to a rear portion 22 of sleeve 14 by pin 24 which extends through holes 23 and 25 respectively in the sleeve 14 and handle 12.

A pivot arm 26 is attached to an upper portion 27 of handle 12. A screw 28 holds the left and right side members 18 and 20 together with arm 26 held there between. A spacer 34 is positioned between left and right handle side members 18 and 20 at a rear portion 31 of handle 12. Spacer 34 includes a spring 36 which, in the assembled form, engages a rear portion 35 of arm 26. An enlarged forward tooth 30 of arm 26 engages a notch 32 in the rear portion 22 of sleeve 14. Handle members 18 and 20 likewise include recesses 37 which allows one to push the rear 35 of the arm 26 downwardly lifting tooth 30 out of engagement with notch 32 permitting the sleeve 14 to rotate relative to the handle 12.

The sleeve 14 is made up of left and right members 52 and 54. The left member 52 is simply a planer piece of metal. Right member 54 includes upper and lower raised areas 56 and 58, and a rear raised area 60. The raised areas are designed to receive and hold the trapezoidal blade 16. The right member 52 further includes an upper recess 62 which is adapted to receive a blade holding arm 64. A screw 68 extends through holes 69 and 71 and through a hole 73 in arm 64 which holds the sleeve member together and allows the arm to pivot relative to the sleeve. One end of arm 64 is a hollow thumb catch 70 which includes a coil spring 72 as shown in FIG. 4. This spring engages ledge 74 on the rear 22 of sleeve 14, urging the thumb catch 70 upwardly away from sleeve 14. The arm 64 further includes two protruding portions 76 which are designed to engage recessed portions 78 in the trapezoidal blade 16.

Referencing FIG. 4, in order to remove or replace the blade, the thumb latch 70 is pressed down, compressing spring 72 and raising the protruding portions 76 of arm 64, as shown by arrow 80. This allows the blade 16 to be removed as indicated by arrow 82. Likewise, a replacement blade can be inserted into the sleeve 14 in the same manner. To close the blade holder into the handle, the rear 35 of arm 26 is pressed downwardly against spring 36. This will raise the tooth 30 taking it out of engagement with the notch 32 of sleeve 14. This allows the blade to rotate as shown by arrows 84 and 86. Once closed, the bottom edge 88 of handle 12 prevents the thumb latch 70 from being depressed preventing the blade from being moved while the blade holder 14 is in the retracted position.

Thus, the mechanism of the present invention provides for a quick and easy replacement of the blade. No screw driver or other implement is required. Further, the device secures the blade in position. Although this is shown in a pocket knife type configuration, the present invention can also be used with a utility knife wherein the sleeve does not pivot relative to the handle. The benefits of the present invention will still be appreciated.

This has been a description of the preferred method of practicing the present invention. However, the invention should only be defined by the pending claims, wherein

1. A utility knife holding a trapezoidal utility knife blade comprising
a handle, a sleeve attached to said handle, said sleeve having an opening adapted to receive said trapezoidal utility knife blade and an arm attached to an upper portion of said sleeve;
said arm adapted to pivot relative to said sleeve from a first position in which said arm engages said blade and retains said blade in said sleeve, to a second position wherein said blade is permitted to slide relative to said sleeve.

2. The utility knife claimed in claim 1 wherein said arm includes a protruding portion adapted to engage recesses in said trapezoidal blade.

3. The utility knife claimed in claim 2 wherein said arm is spring biased into said first position.

4. The utility knife claimed in claim 3 wherein said arm includes a thumb catch.

5. The utility knife claimed in claim 1 wherein said sleeve is pivotally attached to said handle.

6. The utility knife claimed in claim 5 wherein said arm is prevented from moving when said sleeve is folded into said handle.

7. A utility knife comprising a handle and a sleeve pivotally attached to said handle.
said sleeve having an opening and a trapezoidal utility knife blade in said opening;
an arm having a protruding portion pivotally attached to an upper portion of said sleeve, said arm spring biased to a first position wherein said protruding portion of said arm engages an indented portion of said trapezoidal blade;
said arm further adapted to pivot from said first position to said second position wherein said protruding portion is out of engagement with said recessed portion of said utility knife blade thereby permitting said utility knife blade to be removed.
